(19) United States
(12) Patent Application Publication
(10) Pub. No.: US 2026/0357015 A1
(43) Pub. Date: Nov. 12, 2026

(54) EXCITONICALLY COUPLED COACERVATES VIA LIQUID/LIQUID PHASE SEPARATION AND METHODS FOR MAKING THE SAME

(71) Applicant: The Regents of the University of California, Oakland, CA (US)

(72) Inventors: Alexander Ayzner, Santa Cruz, CA (US); Gregory Pitch, Santa Cruz, CA (US); Anna Johnston, Santa Cruz, CA (US); Eris Minckler, Santa Cruz, CA (US)

(21) Appl. No.: 19/111,468

(22) PCT Filed: Sep. 14, 2023
(86) PCT No.: PCT/US2023/074134

§ 371 Date: Mar. 13, 2025

Related U.S. Application Data
(60) Provisional application No. 63/407,010, filed on Sep. 15, 2022.
(60) Provisional application No. 63/434,965, filed on Dec. 23, 2022.

(51) Int. Cl. C08G 81/02; C08K 3/105; C08K 3/11

(52) U.S. Cl. CPC C08G 81/025; C08K 3/105; C08K 3/11

(57) ABSTRACT

A coacervate composition includes an aqueous solution of a salt and a conjugated polyelectrolyte, which includes: a conjugated polymer backbone having a plurality of monomers; ionic sidechains; and polar nonionic sidechains. Each of the ionic sidechains and each the polar nonionic sidechains extends from each monomer of the plurality of monomers in an alternating manner.

### CROSS-REFERENCE TO RELATED APPLICATIONS

This application claims the benefit of, and priority to, U.S. Provisional Patent Application Ser. No. 63/407,010 filed on Sep. 15, 2022, and U.S. Provisional Patent Application Ser. No. 63/434,965 filed on Dec. 23, 2022. The entire contents of the foregoing applications are incorporated by reference herein.

### GOVERNMENT LICENSE RIGHTS

This invention was made with government support under Grant No. 1848069 awarded by the National Science Foundation (NSF). The Government has certain rights in the invention.

### BACKGROUND

Spontaneous separation of aqueous polyelectrolyte solutions into dilute and highly concentrated liquids is a fascinating process relevant to understanding the formation of early membrane-less organelles. Viscoelastic liquid coacervate phases that are highly enriched in non-conjugated polyelectrolytes are currently the subject of highly active research from biological and soft-materials perspectives. However, formation of a liquid, electronically active coacervate has proved highly elusive. Conventional (i.e., prior art) conjugated polyelectrolytes do not form coacervates in pure water or salt water and/or to support the concentrated liquid coacervate phase because they are highly prone to π-stacking interactions. Such interactions strongly favor the solid (amorphous or crystalline) state.

Liquid/liquid phase separation has multiple exciting applications, which stem from the properties of the concentrated viscoelastic fluid phase. Yet to date, the polyelectrolyte components of such coacervate phases have been electronically inactive. Water-based viscoelastic liquids that are highly enriched in polyelectrolytes are attractive for several applications including low-surface tension materials, drug design, catalysis, biomaterials, underwater adhesives, cosmetics, food science, etc. In nature, polyelectrolyte-based viscoelastic liquids are used by organisms as underwater adhesives in salt-water environments. However, such systems (i) do not absorb light in the visible or near-infrared spectrum, and (ii) they cannot effectively move electronic charge through space.

### SUMMARY

The present disclosure provides a conjugated polyelectrolyte (CPE) that is designed to undergo aqueous liquid/liquid phase separation to form a liquid coacervate phase. This result is significant both because it adds to the fundamental understanding of liquid/liquid phase separation, but also because it opens intriguing applications in light harvesting and beyond. The semiconducting coacervate is intrinsically excitonically coupled, allowing for long-range exciton diffusion in a strongly correlated, fluctuating environment. The emergent excitonic states include both excimers and H-aggregates.

The formation of a liquid semiconducting coacervate provides new applications in light-harvesting and electronically conducting soft matter. In such a crowded aqueous system, inter- and intra-chain electronic couplings between semiconducting polymer chains support long-range exciton and charge motion. The strong fluctuations associated with a liquid state would couple to the electronic states of the system, both by influencing the ensemble of chain conformations and by direct interactions between small ions and extended π-electron states. Thus, a local trap state for an exciton in one instance may no longer be a trap in the next. At the same time, the liquid environment allows for molecular diffusion. Such a combination is attractive from a photosynthetic perspective. A semiconducting coacervate droplet according to the present disclosure may be encapsulated in a larger assembly and thereby serve as a photoactive compartment within an overarching soft, artificial photosystem.

Typically, aqueous phase separation of electronically active CPEs leads to precipitants, colloidal gels, and complex fluids in which a solid-like phase persists. Currently, there are no examples of true semiconducting liquid coacervates. An alternating co-polymer CPE composed of one ionic monomer and one highly polar nonionic monomer of the present disclosure allows for stabilization in a liquid coacervate phase. In the limit where long-range electrostatic interactions are strongly screened, enhanced local dipolar interactions of nonionic sidechains with solvent molecules and small ions would compete with interchain π-stacking. The latter strongly favors the formation of solid phases.

The present disclosure provides for a novel polyfluorene-based CPE bearing ionically charged sidechains on one monomer and oligo(ethylene glycol) (oEG) sidechains with a substantial number of repeat units on the other adjacent monomer. In the presence of high-ionic-strength salt (e.g., potassium bromide (KBr)) solutions, the CPE composition undergoes liquid/liquid phase separation and forms spherical coacervate droplets with photophysical properties that differ substantially from the surrounding dilute solution. Thus, the CPE composition is a semiconducting (i.e., electronically active) liquid coacervate.

An electronically active coacervate based on CPE of the present disclosure may be used in a variety of applications such as electronically conducting underwater adhesives and water-based, photoactive, viscoelastic pastes. This could be useful for environmentally benign soldering materials, sensing, color-sensitive coatings and to enhance rates of photochemically driven chemical reactions.

According to one embodiment of the present disclosure, a conjugated polyelectrolyte is disclosed. The conjugated polyelectrolyte includes a conjugated polymer backbone having a plurality of monomers, ionic sidechains, and polar nonionic sidechains. Each of the ionic sidechains and each of the polar nonionic sidechains extends from each monomer of the plurality of monomers in an alternating manner.

Implementations of the above embodiment may include one or more of the following features. According to one aspect of the above embodiment, the plurality of monomers may be selected from the group consisting of fluorene, phenylene, thiophene, benzothiadiazole, bithiophene, benzodithiophene, thienothiophene, and carbazole. The plurality of monomers may include at least two of fluorene, phenylene, thiophene, benzothiadiazole, bithiophene, benzodithiophene, thienothiophene, or carbazole. Each of the ionic sidechains may include an ionic group and at least one alkyl group disposed between one monomer of the plurality of monomers and the ionic group. The at least one alkyl group may be methylene. The ionic group may be disposed in a middle or at terminus of the ionic side chain. The ionic side chain may have an ionic charge of from −2 to +2. The ionic group may be an amine selected from the group consisting of a primary amine, a secondary amine, and a tertiary amine. The ionic group may be also selected from the group consisting of an amine, imidazolium, pyridinium, sulfonate, and carboxylate. Each of the polar nonionic sidechains may include at least one oligo(ethylene glycol) branch extending from a monomer of the plurality of monomers. The oligo((ethylene glycol) may include four or more ethylene glycol units. Each of the polar nonionic sidechains may be selected from the group consisting of aldehyde (R—CHO), ester (R—COOR′), amide (R—CONR′R″), ketone (R—COR′), cyano (R—CN), primary amine (R—NH₂), secondary amine (R—NR′H), tertiary amine (R—NR′R″), and alcohol (R—OH), wherein R is a linear or branched alkyl group extending from a monomer of the plurality of monomers, R′ and R″ are alkyl groups.

According to another embodiment of the present disclosure, a coacervate composition is disclosed. The coacervate composition includes an aqueous solution of a salt and a conjugated polyelectrolyte, which includes: a conjugated polymer backbone having a plurality of monomers; ionic sidechains; and polar nonionic sidechains. Each of the ionic sidechains and each the polar nonionic sidechains extends from each monomer of the plurality of monomers in an alternating manner.

Implementations of the above embodiment may include one or more of the following features. According to one aspect of the above embodiment, the salt may include at least one cation of K⁺, Ca²⁺, Mg²⁺, Fe²⁺, or Fe³⁺. The plurality of monomers may be selected from the group consisting of fluorene, phenylene, thiophene, benzothiadiazole, bithiophene, benzodithiophene, thienothiophene, and carbazole. Each of the ionic sidechains may include an ionic group and at least one alkyl group disposed between one monomer of the plurality of monomers and the ionic group. Each of the polar nonionic sidechains may include at least one oligo(ethylene glycol) branch extending from a monomer of the plurality of monomers. The conjugated polyelectrolyte may be configured to form a liquid coacervate phase in the aqueous solution.

According to a further embodiment of the present disclosure, a coacervate composition is disclosed. The coacervate composition includes an aqueous solution of a salt and a first conjugated polyelectrolyte including: a conjugated polymer backbone having a plurality of monomers; ionic sidechains; and polar nonionic sidechains. Each of the ionic sidechains and each the polar nonionic sidechains extends from each monomer of the plurality of monomers in an alternating manner. The composition also includes a second conjugated polyelectrolyte having an opposite charge from the first conjugated polyelectrolyte.

Implementations of the above embodiment may include one or more of the following features. According to one aspect of the above embodiment, the second conjugated polyelectrolyte is anionic poly(cyclopentadithieno-alt-phenylene).

### BRIEF DESCRIPTION OF DRAWINGS

Various embodiments of the present disclosure are described herein below with reference to the figures wherein:

FIG. 1 shows chemical structures of CPEs according to an embodiment of the present disclosure;

FIG. 2 shows a schematic diagram of synthesis for forming coacervates via liquid/liquid phase separation according to an embodiment of the present disclosure;

FIG. 3 shows a chemical structure of an oppositely charged CPE according to an embodiment of the present disclosure;

FIG. 4 includes images of CPE-based coacervate droplets in which frame (A) is a wide-field transmitted light differential interference contrast (TL-DIC) image of the phase coexistence; frame (B) is a photoluminescence (PL) image with excitation between 340-380 nm and collecting emission between 450-490 nm; frame (C) is a PL image excitation between 450-490 nm and collecting emission between 500-550 nm; frame (D) is a merged PL image; and frame (E) is a bar graph comparing the number of coacervate droplets vs. droplet diameter between 2.5 M and 5.0 M KBr samples;

FIG. 5 includes frames (A)-(F) of fluorescence microscopy images of conjugated polyelectrolyte (PNFG9) in a solution of KBr according to the present disclosure at different concentrations with (A and D) 0.5 M KBr, (B and E) 2.5 M KBr, and (C and F) 5.0 M KBr using two different filters: blue channel (A-C): excitation between 340-380 nm and collecting emission between 450-490 nm and green channel (D-F): excitation between 450-490 nm and collecting emission between 500-550 nm;

FIG. 6 shows a cryogenic-transmission electron microscopy (cryo-TEM) images of coacervate droplets in frames (A) and (B);

FIG. 7 shows a room-temperature phase diagram of another embodiment of conjugated polyelectrolyte (PNFG12) coacervate in the present of aqueous KBr;

FIG. 8 includes frames (A)-(D) of images of PFNG9 w/5.0 M KBr coacervate droplets imaged over approximately 10 minutes 9 seconds;

FIG. 9 includes frame (A) showing a plot of optical density (OD), frame (B) showing photoluminescence (PL) spectra of PFNG9 compared to the separated phases of PFNG9 with 5.0 M KBr; and frame (C) showing PL spectra of droplets at 458, 476, and 498 nm;

FIG. 10 includes frame (A) which shows spectra of normalized steady-state PL comparison of bulk solutions of PFNG9 without added salt and with increasing concentration of KBr and frame (B) which shows spectra comparing PL intensity between the concentrated phase of PFNG9 with 5.0 M KBr and the dilute phase;

FIG. 11 includes frames (A)-(C) showing images of fluorescence recovery of the dilute solution and droplets of PNFG9 by comparing original PL intensity, PL intensity after about 90 s mercury lamp exposure, and PL intensity after a 30 min dark period, respectively, and frames (D) and (E) show bar graphs for fluorescence intensity recovery using excitation from 340-380 nm and emission from 450-490 nm;

FIG. 12 includes frames (A)-(C) showing images fluorescence recovery of the dilute solution and droplets of PNFG9 by comparing original PL intensity, PL intensity after about 107 s mercury lamp exposure, and PL intensity after a 30 min dark period, respectively, and frames (D) and (E) show bar graphs for fluorescence intensity recovery using excitation from 450-490 nm and emission from 500-550 nm;

FIG. 13 is a schematic of a PFNG9 coacervate droplet with regions corresponding to excimer and H-aggregate exciton states and corresponding potential energy curves as a function of the (average) inter-chromophore separation R shown in the side panels;

FIG. 14 includes frame (A) which shows a droplet from a fluorescence lifetime imaging (FLIM) photograph of a PFNG9 coacervate droplet, where pixel selection in the center and on the edge of the droplet are highlighted with white boxes; frame (B) shows a histogram of PL lifetimes measured across the entire droplet; frame (C) shows plots of distance dependent fluctuations in lifetime (symbols) taken from the line cuts shown in the grey scale image of the FLIM image of frame (A), along with corresponding cubic spline curves (solid); and frame (D) shows PL decay curves and fits associated with the selected pixels in (A); and

FIG. 15 includes frames (A)-(F) of fluorescence microscopy images of complex coacervates of PFNG9L and anionic poly(cyclopentadithieno-alt-phenylene) CPE derivative (NaPCPT) in 5 M KBr.

### DETAILED DESCRIPTION

The present disclosure provides a conjugated polyelectrolyte (CPE) that is designed to undergo aqueous liquid/liquid phase separation to form a liquid coacervate phase in an aqueous solution of salt. The CPE also displays semiconducting properties while in the liquid coacervate phase.

FIG. 1 shows three exemplary CPEs according to the present disclosure. The CPEs include a conjugated polymer backbone (i.e., polyfluorene) and alternating ionic sidechains and polar nonionic sidechains. Thus, one fluorene monomer has two ionic (quaternary methylammonium) sidechains with iodide counterions. The second fluorene monomer has oligo(ethylene glycol) sidechains with variable length, corresponding to 6 (PFNG6), 9 (PFNG9) and 12 (PFNG12) ethylene glycol units.

With reference to FIG. 1, the CPE includes a conjugated polymer backbone where a first monomer has ionic sidechains with any counterion and a second monomer that has polar but nonionic sidechains. The ionic and polar sidechains may be permuted between the first and second monomers. The first and second monomers may be the same or may be different. While FIG. 1 shows that the backbone is formed from fluorene monomers, suitable monomers include, but are not limited to, fluorene, phenylene, thiophene, benzothiadiazole, bithiophene, benzodithiophene, thienothiophene, and carbazole.

The ionic sidechains may include any number of methylene (—CH2-) spacers between the first or second monomer of the conjugated polymer backbone and an ionic group, which may be disposed either at the terminus of or in a middle of the ionic sidechain. The alkyl region of the ionic sidechain may be linear or branched. The ionic charge per sidechain may be either +1, +2, −1, −2.

Suitable middle ionic groups may be cationic and may include amines including, but not limited to, primary, secondary, or tertiary amines (e.g., —CH₂—N(CH₃)₂, —CH₂—N(CH₃)H, —CH₂—NH₂), imidazolium, and pyridinium. A neutral amine precursor may be converted to its ionically charged equivalent by exposure to an alkylating reagent such as methyl iodide or ethyl bromide.

The counterion of the cationic sidechain may be any singly charged anion, whether molecular or atomic. The nature of the counterion may be readily varied using a dialysis membrane and an aqueous reservoir solution with the dissolved simple salt containing the desired counterion. Suitable counterions include, but are not limited to, chloride (Cl⁻), iodide (I⁻), fluoride (F⁻), bromide (Br⁻).

Suitable terminus ionic groups may be anionic and may include sulfonate (R—SO₃⁻) or carboxylate (R—COO⁻), where R is the rest of the sidechain (i.e., linear or branched alkyl domain of variable length). In embodiments, where the ionic group is either a sulfonate or carboxylate, the conjugated polymer may be formed by polymerizing a suitable monomer including an acid form of sulfonate (sulfonic acid) or carboxylate (carboxylic acid) and subsequently raising the pH of the solution above 7. In embodiments, the acid forms may be deprotonated prior to polymerization. In further embodiments, the ionic sidechains may also be zwitterionic, including equal numbers of cationic and anionic groups and no counterions.

The polar nonionic sidechain may include oligo(ethylene glycol) (oEG) with 4 or more ethylene glycol units, an aldehyde (R—CHO), ester (R—COOR′), amide (R—CONR′R″), ketone (R—COR′), cyano (R—CN), primary amine (R—NH₂), secondary amine (R—NR′H), tertiary amine (R—NR′R″), alcohol (R—OH), where R is an alkyl (linear or branched) spacer between the conjugated polymer backbone and the polar terminus, R′ and R″ are two different alkyl groups, e.g., CH₃, CH₃CH₂, CH₃—CH₂—CH₂, t-butyl.

Each nonionic monomer may include one or more linear or branched oEG sidechains. In embodiments, the nonionic sidechain may include two branches extending from ta monomer of the conjugated polymer backbone as shown in FIG. 1. In those embodiments, i.e., two oEG sidechains per nonionic monomer, the relative orientation between the sidechains may be variable, i.e., the sidechains may be positioned in the same vertical half-space relative to the polymer backbone, or the sidechains may be approximately perpendicular to each other.

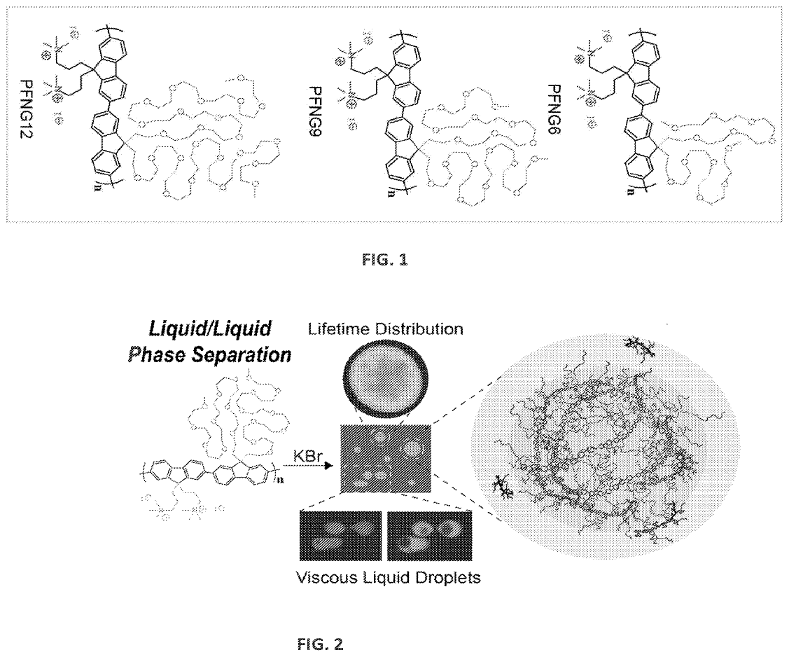

With reference to FIG. 2, the liquid coacervate phase may be formed by adding the CPE to an aqueous salt solution. Suitable salts may include the following ions: potassium (K), magnesium (Mg²⁻), calcium (Ca²⁺), ferrous (Fe²⁺), ferric (Fe³⁺), and the like.

In embodiments where the nonionic sidechain includes oEG, suitable salts may include K⁺ and/or Mg²⁺ cations. In embodiments wherein the nonionic sidechain is selected from one of the other types (i.e., not oEG) listed above, suitable salts may include Ca²⁺, Mg²⁺, Fe²⁺, Fe³⁺ cations. Salts may include any suitable anion, such as, chloride (Cl⁻), iodide (I⁻), fluoride (F⁻), bromide (Br⁻). Salt may be present in the solution at a concentration from about 3 M to about 5 M.

When added to the aqueous solution, CPE forms form a liquid coacervate phase resulting in viscous liquid droplets. CPE may be added to the solution at a concentration from about 2 mM to about 5 mM or from 1 mg/mL to 50 mg/mL for PFNG12.

Liquid coacervates may be also formed with two oppositely charged CPEs that form complex coacervates via associative liquid/liquid phase separation. One of the CPEs may have a chemical structure as described above with respect to FIG. 1, i.e., an alternating copolymer with one monomer with ionic sidechains and one monomer with polar nonionic sidechains.

The second CPE is oppositely charged from the first CPE. The second CPE may be a conjugated homopolymer with ionic sidechains of any type listed above and any monomer listed in the polymer backbone section above. The polymer may also be an alternating copolymer with one monomer with one or more ionic sidechains and one (i) unfunctionalized monomer (without a sidechain) listed above in the polymer backbone section or (ii) a functionalized monomer with a polar nonionic sidechain as listed above in the sidechain section.

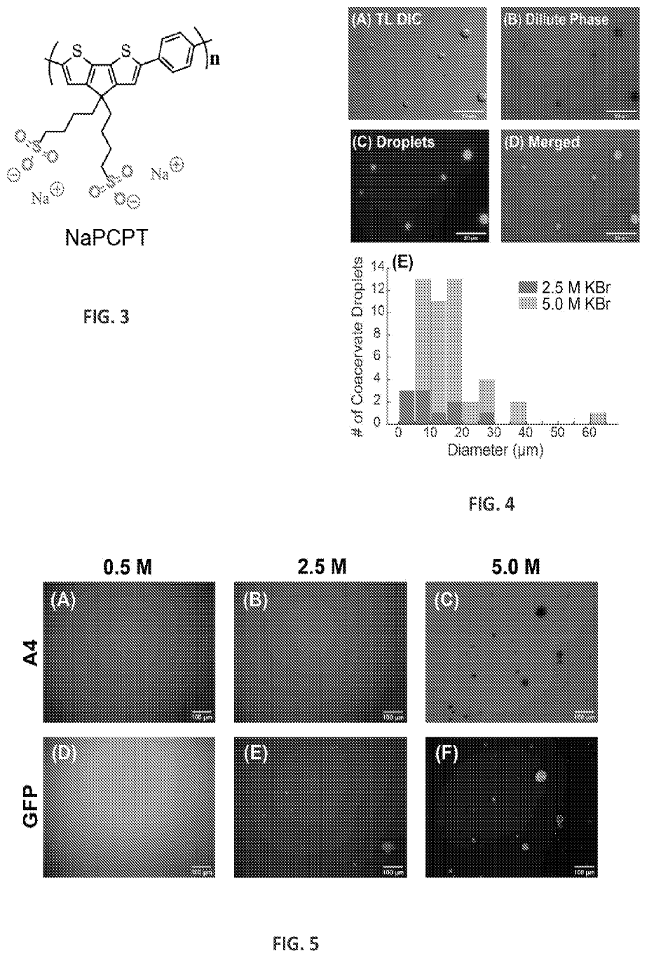

With reference to FIG. 3, an oppositely charged CPE, which may be an anionic poly(cyclopentadithieno-alt-phenylene) CPE derivative (NaPCPT), may be used to form complex coacervates with cationic PFNGX polymers (X=6, 9, 12) of FIG. 1. To form simple or complex coacervates, the appropriate CPEs are dissolved in water without added salt and then combined each polymer or with appropriate amounts of aqueous salt solution to form the final desired salt and polymer concentration. The solution may be heated to a temperature of from about 60 °C to about 80 °C from about 1 hour to about 8 hours to form liquid coacervates. A more detailed synthesis is described below in the Examples.

The coacervate phase may be mechanically isolated from the dilute solution, e.g., filtering and exhibit strong adhesive properties while being electronically active as shown in the Examples below. Thus, the coacervates according to the present disclosure may be used as electronically active underwater adhesives. In further embodiments, the liquid CPE coacervates may be electronically doped to convert the liquid CPE coacervate from a semiconducting to a conducting viscoelastic liquid.

The following Examples illustrate embodiments of the present disclosure. These Examples are intended to be illustrative only and are not intended to limit the scope of the present disclosure. Unless stated otherwise, the Examples described below were performed at a temperature of from about 20 °C to about 25 °C, with relative humidity from about 30% to about 50%, and pressure of about 1 standard atmosphere. The values (e.g., weights, percentages, volume, etc.) provided in the Examples are approximate.

### Example 1

This Example describes synthesis of reagents for making conjugated polyelectrolytes according to the present disclosure.

### Synthesis of (1-(p-tosyl)-3,6,9,12,15,18,21,24,27-nonaoxooctacosane (TG9)

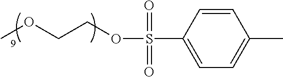

To a clean and dried 25 mL round bottom flask placed in an ice bath, a Teflon-coated stir bar, NaOH (0.80 g, 20.0 mmol), deionized (DI) H₂O (4.0 mL, 222 mmol), nonaethylene glycol monomethyl ether (G9OH, 3.00 g, 7.0 mmol), and THF (8.0 mL, 98.6 mmol) were added and allowed to react for 30 minutes. Next, P-toluene sulfonyl chloride (PTSC) (2.40 g, 12.6 mmol) was added under an atmosphere of N₂ (g) and reacted for 12 hours. Upon completion, the reaction contents were added to 16 mL of cold DI H₂O, followed by extraction of the product with dichloromethane (DCM) (4×10 mL). The organic layer was washed with DI H₂O (2×10 mL), brine (1×10 mL), and subsequently dried over Na₂SO₄. The anhydrous organic layer was decanted away from the drying agent and concentrated under reduced pressure to provide the product TG9 as a colorless oil (99% yield, 4.06 g).

### Synthesis of (2,7-dibromo-9,9-bis(3′-(N,N-dimethyl-amino)-propyl)-fluorene) (FN)

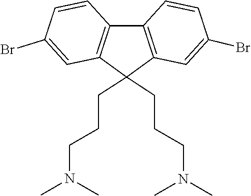 [SMILES: CN(C)CCCC1(CCCN(C)C)c2cc(Br)ccc2-c2ccc(Br)cc21]

To a clean, dried, 100 mL two neck round bottom flask, a Teflon coated stir bar, dimethyl sulfoxide (DMSO, 30.9 mL, 434.6 mmol), 2,7-dibromofluorene (F, 2 g, 6.2 mmol), tetrabutylammonium bromide (TBAB, 39.8 mg, 0.12 mmol), and 4 mL of a 50 wt. % aqueous sodium hydroxide solution (50 wt. % aq. NaOH, 4 mL, 154.3 mmol) was added under an atmosphere of nitrogen (N₂ (g)). An additional aliquot of DMSO (10.5 mL, 145.1 mmol) was added to the reaction flask, followed by dimethyl aminopropyl chloride hydrochloride salt (DAPCl, 2.6 g, 16.4 mmol). The reaction was stirred and heated at 60 °C for 12 hours. Reaction progress was monitored by thin-layer chromatography (TLC). Deionized water (DI H₂O, 40 mL, 2.216 mmol) was added to the reaction flask to dissolve precipitated salts as well as to solvate DMSO. The product (FN) was extracted from the wet DMSO layer with diethyl ether (Et₂O, 8 ×25 mL), and washed with a 10 wt. % aqueous NaOH (10 wt. % aq. NaOH, 2×50 mL). The organic layer was washed with DI H₂O (3×50 mL), followed by a brine wash (1×50 mL), and then dried over anhydrous sodium sulfate (Na₂SO₄). The concentration of the anhydrous organic layer under reduced pressure lead to crude solid which was purified with a silica gel column (Hexanes: Ethyl Acetate: Triethylamine, 49:49:2) to obtain FN (59% yield, 1.81 g).

### Synthesis of (2,7-diboryl pinacol ester-9,9-bis(3′-(N,N-dimethyl-amino)-propyl)-fluorene) (FNB)

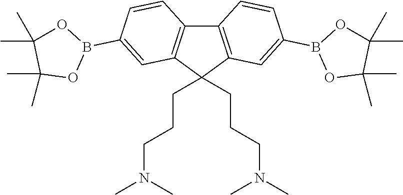

To a clean, dried, 100 mL two neck round bottom flask, a Teflon coated stir bar, dimethylformamide (DMF, 39 mL, 505.8 mmol), FN (1 g, 2.0 mmol), bis(pinacolato)diboron (B₂Pin₂, 2.26 g, 8.9 mmol), potassium acetate (KOAc, 3.53 g, 17.8 mmol), [1,1′-Bis(diphenyl-phosphino) ferrocene]dichloro-palladium(II) (Pd(dppf)Cl₂, 0.296 g, 0.40 mmol) were added under an atmosphere of N₂ (g). The contents of the reaction were stirred and heated at 80 °C for 24 hours. Reaction progress was monitored by TLC. Upon completion, the reaction was concentrated to dryness, and the crude solid was extracted with hot HPLC-grade hexanes (7×100 mL). The combined hexanes layer was filtered, concentrated to dryness, reextracted with hot hexanes, and re-concentrated to dryness. Acetone was used to extract the product from the re-dried hexanes layer and was allowed to crystallize out of the solution as an off-white solid. The FNB crystals were collected via filtration and washed with a minimal amount of cold acetone to obtain FNB (55% yield, 0.6647 mg).

### Synthesis of (2,7-dibromo-9,9-bis-(2-(2-(2-(2-(2-(2-(2-(2-(2-methoxy-ethoxy)ethoxy) ethoxy)ethoxy)ethoxy)ethoxy)ethoxy)ethoxy)ethyl)-fluorene) (FG9)

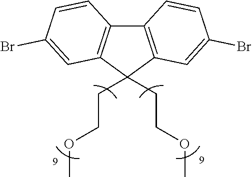

To a clean and dried 50 mL round bottom flask, a Teflon coated stir bar, F (670 mg, 2.1 mmol), anhydrous DMF (12 mL, 155 mmol), and NaH in 60% w/w dispersed in mineral oil (210 mg, 5.3 mmol) were added under an inert atmosphere of N₂ (g). After 30 minutes, the bright red solution was allowed to react at 60 °C for 12 hours with previously prepared TG9 (3.0 g, 5.2 mmol). After quenching the remaining NaH with DI H₂O (15 mL), the reaction was extracted with DCM (4×50 mL). The combined organic layer was dried over Na₂SO₄. The anhydrous organic layer was decanted away from the drying agent. While stirring, a mixture consisting of 95% DCM with 5% Methanol (MeOH) was used to wash the product from the Na₂SO₄ slurry. The DCM: MeOH solution was decanted from the Na₂SO₄ and combined with the organic layer. The organic layer was concentrated under reduced pressure to provide a semi-crude solid which was purified further via a silica gel column (Ethyl Acetate: MeOH, 90:10). Since the percentage of MeOH in the solvent used to elute the aggregated fraction of FG9 was 10%, FG9 was dissolved in chloroform (CHCl₃) to help precipitate out the once dissolved silica gel. The CHCl₃ solution was then filtered to remove the precipitate and concentrated under reduced pressure to obtain FG9 (30.0% yield, 0.710 g).

### Polymerization of poly([9,9-bis(3′—(N,N-dimethyl-amino)-propyl)-fluorene]-alt-co-[9,9-bis-(2-(2-(2-(2-(2-(2-(2-(2-(2-methoxy-ethoxy)ethoxy)ethoxy)ethoxy)ethoxy)ethoxy)ethoxy) ethoxy)ethyl)-fluorene] (nPFNG9 Polymer)

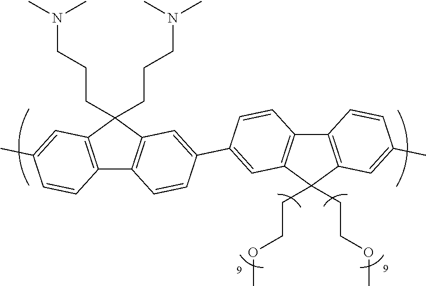

To a clean and dried 48 mL pressure tube, a Teflon coated stir bar, FG9 (1140 mg, 1.00 mmol), FNB (580 mg, 0.99 mmol), potassium carbonate (K₂CO₃, 1.73 g, 12.5 mmol), 1,4-dioxane (dioxane, 10.0 mL, 136.0 mmol), DI H₂O (6.0 mL, 332.4 mmol), and Pd(dppf)Cl₂ (10 mg, 0.01 mmol) were added. The reaction solution as well as the head space was flushed with N₂ (g). The pressure vial was capped quickly, placed into a silicon oil bath, stirred, and heated at 100 °C for 24 hours. To stop the reaction, the stirring function was turned off, the bottom water layer was removed, and an aliquot of nPFNG9 dispersed in dioxane was removed for further characterization. The polymer in dioxane (1 mL) was pipetted into DI H₂O (10 mL) to induce precipitation of nPFNG9. The water was decanted from the polymer and nPFNG9 was dried via vacuum filtration.

Polymer molecular weight was measured by triple-detection size exclusion chromatography (SEC) using a Malvern OmniSEC equipped with refractive index, light scattering, and intrinsic viscosity detectors calibrated with a single poly(styrene) standard. Analysis was performed in tetrahydrofuran running at 1 mL min-1 and 35 °C. SEC measurements for nPFNG6 provided a number-average molecular weight of 39,720 g/mol and a polydispersity of 1.16.

### Example 2

### This Example Describes Synthesis of Conjugated polyelectrolyte-poly([9,9-bis(3′—(N,N,N-trimethyl-ammonium)-propyl)-fluorene]-alt-co-[9,9-bis-(2-(2-(2-(2-(2-(2-(2-(2-(2-methoxy-ethoxy)ethoxy)ethoxy)ethoxy)ethoxy)ethoxy)ethoxy)ethoxy)ethyl)-fluorene] (PFNG9)

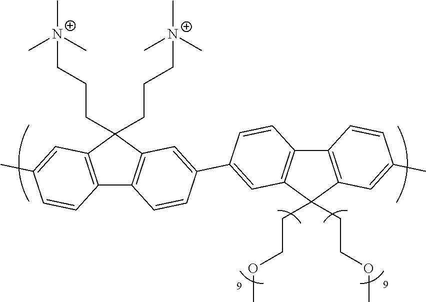

The dioxane containing nPFNG9 was transferred into a 350 mL pressure vessel. Then quaternization occurred via the addition of methyl iodide (Mel, 1.0 mL, 16.1 mmol) directly to the remaining dioxane layer containing nPFNG9. The cap was threaded onto the pressure vessel, heated to 80 °C for 24 hours, and allowed to cool back down to room temperature before the cap was unscrewed. An aliquot of DI H₂O (200 mL) was added to help dissolve the precipitated polymer. The cap was threaded back onto the pressure vessel and was reheated to 80 °C for an additional 3 days. After which, the pressure vessel was cooled down to room temperature and uncapped. Once the cap was removed, the reaction contents were reheated to 80 °C to remove unreacted Mel from the reaction and reduced the volume of the reaction to 250 mL. The polymer solution was then dialyzed via a dialysis flask (10,000 MWCO) submerged in a vat of DI H₂O. The DI H₂O was replaced with fresh DI H₂O every day for 5 days. After 5 days, the dialyzed solution of PFNG9 was concentrated under reduced pressure, filtered, transferred into a 50 mL Falcon tube, and lyophilized to yield PFNG9 as a brown solid (320 mg, 24.6% yield).

### Example 3

This Example describes synthesis of excitonically coupled coacervates via liquid/liquid phase separation.

Potassium bromide (KBr, 99.99% purity) was obtained from Sigma-Aldrich. Tetraethylammonium bromide (>98.0% purity) (TEAB) from TCI Chemicals, and calcium bromide (CaBr₂, extra pure) from Fisher Scientific. All chemicals were used as received. Stock solutions of 11 mg/mL PFNG9, 5.0 M KBr, 7.0 M LiBr, and 7.0 M TEAB were prepared using degassed (argon) high-performance liquid chromatography (HPLC) grade water (Sigma-Aldrich). The PFNG9 stock was stirred at 70 °C for 6 hrs in a light protected vial. The salt stocks were stirred and heated at 70 °C for 15 min to guarantee all salt crystals were fully dissolved.

The PFNG9 concentration was fixed at 4.624 mg/mL for all solutions. Samples containing 5.0 M KBr were made with solid KBr; samples at 0.5 M and 2.5 M KBr were made using degassed KBr stock. The order of addition was as follows: KBr, HPLC water, PFNG9. Samples were stirred at 250 rpm at 70 °C for 6 hrs. Samples were allowed to cool to room temperature before any analysis was performed and care was taken to limit ambient light exposure. All other samples containing TEAB or CaBr₂ were made using degassed salt stocks in using the same prep described above.

### Example 4

This Example describes analysis of excitonically coupled coacervates of Example 3.

Images were acquired using a Leica DM5500 B widefield microscope equipped with a Leica DCF360 monochrome camera using ∞/0.17/o, HCX PL FLUORTAR 10×/0.3 and ∞/0.17/o, HCX PL FLUORTAR 40x/0.75 objectives. Samples were mixed to homogenize the dilute and coacervate phases. Samples were excited using the Blue Channel (A4): excitation at 340-380 nm; emission at 450-490 nm and Green Channel (GFP): excitation at 450-490 nm; emission at 500-550 nm.

The A4 filter was chosen to select for the emission of the dilute phase and a GFP filter was used to select for the emission of the coacervate phase. Samples were also imaged using transmitted light DIC when using a 40× objective.

A Leica SP5 Confocal Microscope was used to collect PL spectra from regions of interest in an image after performing a xyλ scan, in which the excitation wavelength was fixed, and the detected emission wavelength was scanned in 5-nm increments. Images were collected using a 20x/0.75 objective at 16-bit resolution. xyλ scans were taken while exciting with 405, 458, 476, and 496 nm laser lines, and emission was detected out to 750 nm.

Frame A of FIG. 4 shows the wide-field differential interference contrast (TL-DIC) light microscopy image of an aqueous sample that contains PFNG9 (4.6 mg/mL; 2.8 mM in monomer) and 5.0 M KBr. Spherical liquid droplets were observed to be dispersed through the background dilute phase—an appearance that differs drastically from all other reported CPE-based complex fluids. Frame B of FIG. 4 shows the corresponding photoluminescence (PL) image where the sample was excited between 340-380 nm, and emission was collected between 450-490 nm. Within these illumination and emission bands, the dilute-phase PL is strongly enhanced, while droplets appear significantly darker. In contrast, illuminating the sample between 450-490 nm and collecting emission between 500-550 nm as shown in Frame C of FIG. 4, the dilute phase is darkened while the coacervate droplets are highly fluorescent. Clearly, the two phases are photophysically distinct from one another and the dissolved CPE in the absence of KBr.

A phase transition was observed from more precipitant-like, fractal particle morphologies to the characteristic liquid droplet morphology conventionally associated with coacervates. FIG. 5 shows that this transition occurs between 2.5-5.0 M KBr with the disappearance of fractal particles at 2.5 M KBr, giving way to well-defined droplets at 5.0 M KBr (Frames C and F). The droplet size distribution was quantified using light microscopy at 2.5 and 5.0 M KBr, which is shown in Frame E of FIG. 4. The number density and the observed size range of coacervate droplets are substantially larger at 5.0 M KBr. This distribution reflects droplets that could be imaged using optical microscopy.

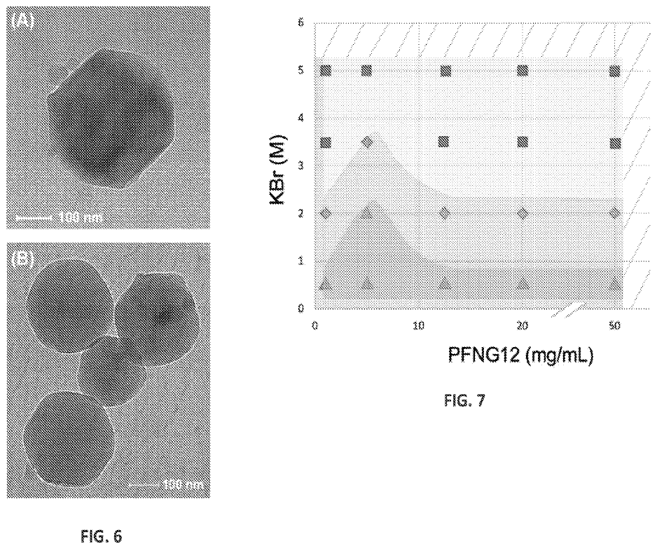

Droplets that are smaller than the diffraction limit were not counted. There were many such nanoscale and mesoscale droplets, as seen in cryo-TEM images of FIG. 6. Thus, the calculated size distributions from optical microscopy primarily reflect the micron-scale sub-population. In cryo-TEM images of FIG. 6, the dark regions correspond to fluctuations in local KBr concentration near the onset of crystallization. The latter was confirmed by the presence of weak Bragg reflections at large scattering angles. Frame (B) of FIG. 6 shows multiple droplets overlapping with one another.

FIG. 7 shows a room-temperature phase diagram of the PFNG12 simple coacervate in the presence of aqueous KBr. The y-axis is the KBr concentration, and the x-axis is the PFNG12 concentration. Hashed regions correspond to unexplored (PFNG12 concentration >50 mg/mL) or metastable regions (KBr concentration >5 M). The bottom region corresponds to a homogeneous solution, i.e., no phase separation. The middle region corresponds to a coexistence of a dilute solution with solid-like particles. The top region corresponds to a three-phase coexistence of the dilute solution, solid particles and liquid droplets. The blue region corresponds to a coexistence between the dilute solution and liquid droplets (see FIG. 4).

A sample droplet of 4 μL at 4.624 mg/mL PFNG9 and 5.0 M KBr was deposited on a C-flat holey carbon-coated TEM support grid (CF-2/2-2C from Electron Microscopy Services-EMS) previously glow-discharged (PELCO easyGLOW) using 15 mA for 30 s. The sample was blotted for 2.5 s using a Vitrobot Mark IV (FEI Company) at 22 °C and ~100% humidity and sequentially fast-plunged into liquid ethane. The images were acquired using 1-s exposure on a 4k×4k CETA CCD Camera coupled to a ThermoFischer Glacios cryo-TEM operating at 200 kV. Images were collected at a nominal 2 Å pixel size, 73,000× magnification, and −3.5 μM defocus. Fiji-ImageJ was used for data analysis.

Steady-state PL spectroscopy was collected using a laser system. Samples were excited in a front-face geometry with 375-nm light from a pulsed picosecond diode laser (BDS-SM Series, Becker & Hickl GmbH), and emission was collected between 400-700 nm using a PIXIS 100 CCD (Princeton Instruments).

Bulk-solution time-resolved photoluminescence (TRPL) measurements were also collected using time-correlated single photon counting. Samples were excited at 375 nm using a pulsed picosecond diode laser (BDS-SM Series, Becker & Hickl GmbH) or at 445 nm using a pulsed supercontinuum picosecond laser (Super K EXTREME, NKT Photonics) coupled to an acousto-optic filter and an external RF driver (Super K SELECT, NKT Photonics). The excitation beam was vertically polarized, and emission was collected in a front-face geometry with the emission polarizer set to the magic angle. PL lifetimes were determined using forward convolution with the measured instrument response function taken using a scattering Ludox sample. This was done using least-squares minimization via the DecayFit MATLAB package developed by Soren Preus (Fluorescence Decay Analysis Software 1.3, FluorTools, www.fluortools.com). A sum-of-exponentials model was used for the decay.

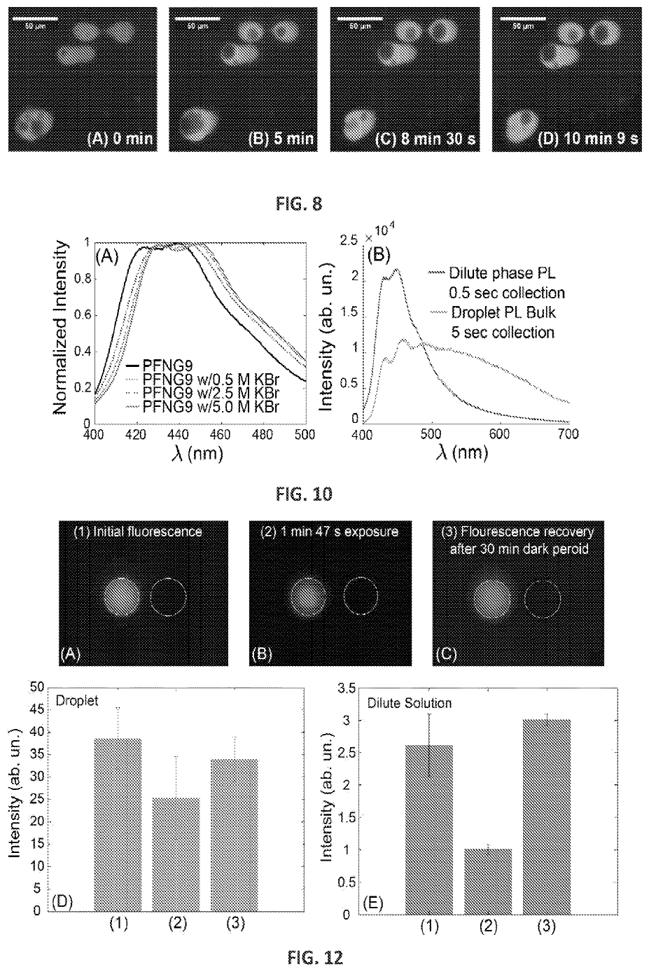

FIG. 8 shows the time points of a PL microscopy video in which the flow behavior of the droplets was observed. The fluid dynamics were quite slow, which is consistent with the high apparent viscosity of the concentrated phase observed when handling the sample. The droplet dynamics were characteristic of a true viscous liquid as opposed to a colloidal gel.

One of the most interesting aspects of a semiconducting coacervate is the influence of the highly correlated and strongly fluctuating environment on the ensemble of electronic states of the constituent CPE chains. To interrogate the emergent photophysical properties associated with the formation of this coacervate phase, a combination of steady-state and time-resolved PL spectroscopy methods were used.

Frame A of FIG. 8 shows absorption or optical density (OD) spectra of dilute and concentrated phases, which were acquired by carefully separating the phases. Upon addition of 5.0 M KBr, the OD spectrum of the dilute phase underwent a mild redshift relative to aqueous PFNG9 solutions without added salt. This likely reflected an increased propensity for intrachain T-stacking interactions as repulsion between ionic sidechains became strongly screened. In contrast to the mild redshift for the dilute solution, the OD spectrum of coacervate droplets acquired a substantial red shoulder, which implied that new electronic states form within the coacervate.

To directly compare PL spectra of the dilute solution and the coacervate droplets, laser-scanning confocal microscopy was used. Frame B of FIG. 8 shows that, when exciting at 405 nm, the dilute solution and the coacervate displayed a blue emission band that decayed by ~550 nm. At the same excitation wavelength, the coacervate phase gave an enhanced PL intensity on the red side of the dilute-solution PL spectrum, consistent with widefield PL microscopy images in FIG. 4. When exciting at 458 nm near the onset of red shoulder in the coacervate OD spectrum, the droplets exhibited a new, broad green emission band. A similarly broad green band for the concentrated phase was observed when physically separating the concentrated phase from the dilute phase and performing bulk PL measurements (see FIG. 10).

The appearance of this green band (commonly shortened to g-band) appears in a number of polyfluorene derivatives. This is due to the fact that the g-band may be composed of H-aggregate exciton states as well as fluorenone-defect-based states. However, the PFNG9 chains in the dilute solution surrounding coacervate droplets display no g-band emission. In dilute solution, PFNG9 chains are effectively isolated. Therefore, the g-band emission cannot be explained by fluorenone defects on single chains. To further probe the nature of the PFNG9 g-band within the coacervate, recovery of PL signal was measured after light exposure to elucidate whether the coacervate was undergoing an irreversible photochemical reaction. The PL intensity was found to be for both the dilute solution and droplets fully recovered after about 1 and about 30 s light exposure under the microscope (See FIGS. 11 and 12). These results do not support the hypothesis that photodegradation by irreversible formation of fluorenone defects in the CPE backbone is leading to g-band emission.

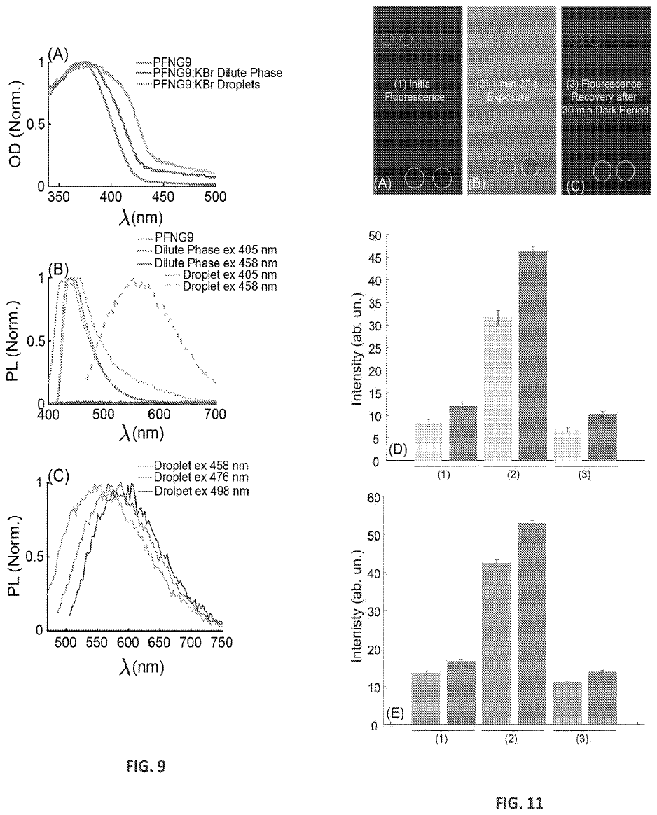

The emission spectra of conjugated polymers in the solid state are independent of excitation wavelength over wide regions of the absorption spectrum. In contrast, the data in the g-band within the coacervate show that the structure of the g-band undergoes significant changes. The shoulder on the blue side of the spectrum disappears as the excitation wavelength goes from 458 nm to 498 nm. This suggests that different populations of distinct emitting species are excited as the excitation wavelength is increased. The presence of two emissive species is supported by the approximate decomposition of the PL spectra in frame C of FIG. 9 into two distinct contributions with excitation wavelength-dependent amplitudes. This consistent with single-molecule measurements, which provided evidence that the g-band of polyfluorene chains with intrachain interactions consisted of multiple emitting species.

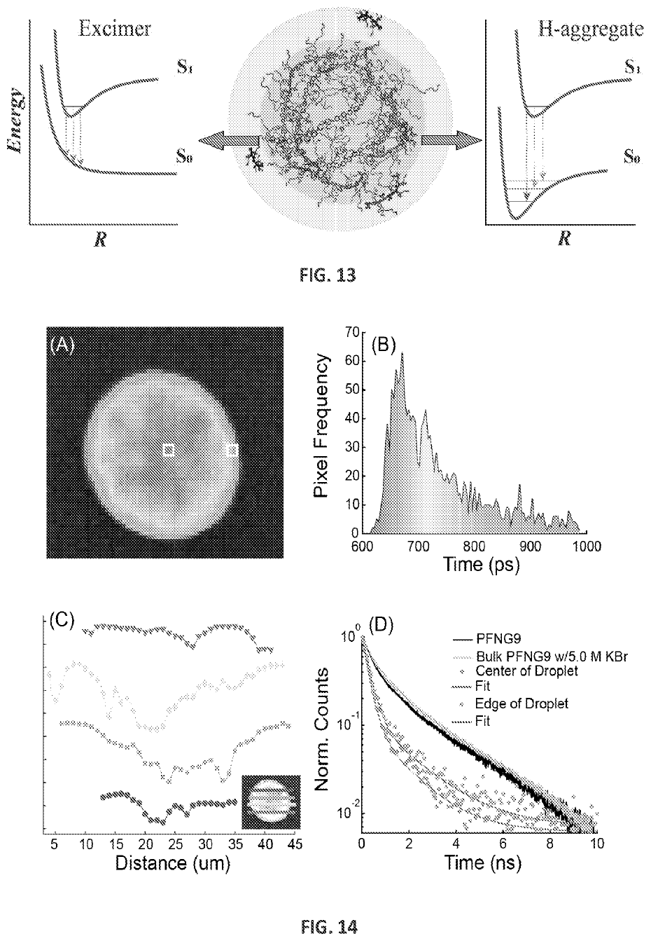

Given the inherent proximity between chains within the crowded coacervate environment and the lack of g-band emission in the dilute phase, the coacervate g-band is likely primarily composed of interchain exciton states. The fact that only one new, relatively narrow absorption band appears within the coacervate but that two putative emissive species include the g-band PL spectrum is consistent with a coexistence of excimers and H-aggregate excitons within a coacervate droplet. Evidence for H-aggregate formation is provided by the appearance of a new redshifted absorption band in the OD spectrum of the coacervate compared to the dilute phase (frame A of FIG. 4). Fluorenone defects also contribute to the coacervate emission spectrum. However, it must still then be the case that emission from fluorenone-based states requires an inter-chromophore excitonic coupling. Thus, the PL spectra support the finding that the CPE coacervate of Example 3 is an intrinsically excitonically coupled viscoelastic liquid as shown in FIG. 13. Regions corresponding to excimer and H-aggregate exciton states are labeled as magenta domains with few or extended interchain contacts, respectively. Illustrations of the corresponding potential energy curves as a function of the (average) inter-chromophore separation R are shown in the side panels.

To gain a better understanding of the coacervate photophysics, fluorescence lifetime imaging (FLIM) was used to characterize the radiative relaxation of dilute-phase and coacervate excitons. FLIM was used to measure PL lifetimes as a function of position within the droplet. Frame A of FIG. 14 shows the heat map of PL lifetimes of a representative droplet following excitation at 445 nm while collecting emission in the 590±25 nm region. The average PL lifetime [symbol] τ [symbol] calculated for individual coacervate droplets was found to be between 560-830 ps. The PL lifetime histogram (frame B of FIG. 14) highlights differences in lifetime found throughout the droplet where the color-coding of the histogram matches that in the FLIM heat map.

FLIM measurements were carried out using a Zeiss LSM 980 NLO confocal microscope (Becker-Hickl TCSPC FLIM). Samples were excited using a 445-nm laser line, and PL was collected using a 590/50 nm filter cube. Images were collected using a 512×512 pixel resolution and a 50-s collection time. Fluorescence lifetime averages and distributions were determined using the SPCImage 8.5 NG software via the maximum likelihood estimation method.

The FLIM heat map shows that [symbol] τ [symbol] is a function of position within the droplet, demonstrating that [symbol] τ [symbol] is a fluctuating variable within the coacervate. This observation is consistent with the viscous liquid macrostate. To characterize the approximate length scale of [symbol] τ [symbol] fluctuations, in frame C of FIG. 14 four (4) linecuts were plotted through the droplet shown in the FLIM image of a droplet of the frame A of FIG. 14. The extracted image grey value as a function of position for the different linecuts shows that relatively small fluctuations in [symbol] τ [symbol] occur on the ~1 μm scale, while larger fluctuations are also seen on the ~10 μm scale. Differences in [symbol] τ [symbol] must reflect differences in local structure. The large viscosity of the droplet may lead to a relatively slow interconversion between large, entangled CPE networks and relatively loosely associated domains with fewer inter-chain interactions. However, within the droplet interior, the mean fluctuation in [symbol] τ [symbol] is not dramatic, as seen from the histogram in the frame B of FIG. 14, suggesting relatively subtle differences in structure as a function of position.

The PL lifetime was somewhat longer near the edge of the droplets than in the center. This is shown in frame C of FIG. 14, which compares decays collected in the middle of the droplet to that of the near-surface region (indicated by squares in the image of the frame A of FIG. 14). In going from the bulk to the surface of the droplet, the lifetime of the short component increased from 255 ps to 298 ps, while the lifetime of the long component increased from 1367 ps to 1693 ps. The difference between bulk and surface lifetimes increased closer to the edge of the droplet, as seen from the lifetime histogram and the corresponding FLIM image. The change in the (intensity-weighted) contribution was calculated for the regions labeled with white squares, i.e., that each component makes to the total decay, fᵢ, according to fᵢ=αᵢτᵢ/Σⱼαⱼτⱼ, where αᵢ and τᵢ are the amplitude and lifetime of component i, respectively, fₛₕₒᵣₜ decreased by ~8% while f_{long} increased by ~16% for the near-surface region relative to the middle. Since longer lifetimes are often associated with more extended chains, the PFNG9 backbone underwent a relative extension near the surface. This allowed polymer chains to maximize the number of oEG sidechains capable of orienting approximately normal to the droplet/solution interface, thereby likely lowering the surface free energy.

Unlike overwhelming majority of CPEs, PFNG9 formed a liquid coacervate phase. Although it was reasonable to expect that the oEG sidechains are implicated, it was not immediately clear what contribution(s) they make to the system free energy such that the liquid state becomes stabilized at high [KBr]. There is no interaction with an oppositely charged polyelectrolyte, as would occur in a complex coacervate. Therefore, in the simple PFNG9 coacervate it is likely that the interaction between the excess ions and the oEG sidechain played a role in inducing the formation of this viscoelastic liquid phase. It is known that K⁺ ions readily interacted with crown ethers, which are chemically related to the oEG sidechains.

In order to determine whether the ionic strength was responsible for coacervate formation independent of ion identity or whether the identity of the cation was an important factor similar samples were prepared using comparable concentrations of other salts, namely, lithium bromide (LiBr), tertraethylammonium bromide (TEAB), and calcium bromide (CaBr₂). Liquid coacervate formation was not observed in the presence of any other salts chosen for this study. It was concluded that the specific K⁺-oEG interaction is likely involved in the stabilization of the coacervate phase. The large viscosity of the droplets is then a consequence of both inter-chromophore π-stacking and a large number of K⁺ ions interacting with a correspondingly large number of ethylene glycol groups.

This disclosure demonstrated that the chemical structure of a CPE can be designed to undergo liquid/liquid phase separation to stabilize a semiconducting coacervate macrostate, which is of fundamental interest to coacervate physical chemistry. Oligo (ethyleneglycol) sidechains provide for a simple coacervation process, which involves the interaction between ethyleneglycol units with K⁺ ions. The CPE coacervate is composed of intrinsically excitonically coupled chains with rich exciton dynamics in the presence of a fluctuating ionic environment. This observation is intriguing from an applications standpoint of the coacervates according to the present disclosure. The electronic connectivity within the concentrated liquid may be used to move excitons, electrons or holes through space over distances that are large compared to the monomer size. The strong coupling between and electronic and ionic degrees of freedom may be used to manipulate this quasiparticle migration. These characteristics are likely to be desirable for light harvesting, catalysis or sensing. Finally, semiconducting coacervate droplets may be encapsulated in larger soft-matter assemblies, leading to the potential for compartmentalization and a significant increase in light-harvesting complexity.

### Example 5

This Example describes synthesis of complex coacervates.

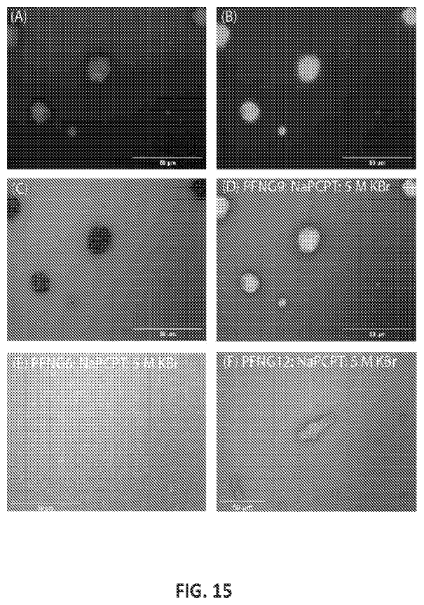

Complex coacervates were formed by combining anionic poly(cyclopentadithieno-alt-phenylene) CPE derivative (NaPCPT) of FIG. 3 with cationic PFNGX polymers (X=6, 9, 12) of FIG. 1. With reference to FIG. 15, fluorescence microscopy images of PFNG9:NaPCPT complex coacervates with 5 M KBr were obtained using: in frame (A) 360±20 nm excitation and 470±20 nm emission, frame (B) 470±20 nm excitation and 525±25 nm emission, and frame (C) 560±30 nm excitation and 625±37 nm emission. Frame (D) shows an overlay of all fluorescence images of frames (A)-(C) with the same optical filters for the PFNG9: NaPCPT complex, frame (E) shows an overlay for the PFNG6: NaPCPT complex, and (F) shows an overlay for the PFNG12: NaPCPT complex.

Various aspects of the present disclosure may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

It will be appreciated that of the above-disclosed and other features and functions, or alternatives thereof, may be desirably combined into many other different systems or applications. Various presently unforeseen or unanticipated alternatives, modifications, variations or improvements may be subsequently made by those skilled in the art which are also intended to be encompassed by the following claims. Unless specifically recited in a claim, steps or components of claims should not be implied or imported from the specification or any other claims as to any particular order, number, position, size, shape, angle, or material.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately” and “about” may be used to mean within +20% of a target value in some embodiments, within +10% of a target value in some embodiments, within +5% of a target value in some embodiments, and yet within +2% of a target value in some embodiments. The terms “approximately” and “about” may include the target value.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A conjugated polyelectrolyte comprising:
a conjugated polymer backbone including a plurality of monomers;
ionic sidechains; and
polar nonionic sidechains, wherein each of the ionic sidechains and each the polar nonionic sidechains extends from each monomer of the plurality of monomers in an alternating manner.

2. The conjugated polyelectrolyte according to claim 1, wherein the plurality of monomers is selected from the group consisting of fluorene, phenylene, thiophene, benzothiadiazole, bithiophene, benzodithiophene, thienothiophene, and carbazole.

3. The conjugated polyelectrolyte according to claim 1, wherein the plurality of monomers includes at least two of fluorene, phenylene, thiophene, benzothiadiazole, bithiophene, benzodithiophene, thienothiophene, or carbazole.

4. The conjugated polyelectrolyte according to claim 1, wherein each of the ionic sidechains includes an ionic group and at least one alkyl group disposed between one monomer of the plurality of monomers and the ionic group.

5. The conjugated polyelectrolyte according to claim 4, wherein the at least one alkyl group is methylene.

6. The conjugated polyelectrolyte according to claim 4, wherein the ionic group is disposed in a middle or at terminus of the ionic side chain.

7. The conjugated polyelectrolyte according to claim 4, wherein the ionic side chain has an ionic charge of from −2 to +2.

8. The conjugated polyelectrolyte according to claim 4, wherein the ionic group is an amine selected from the group consisting of a primary amine, a secondary amine, and a tertiary amine.

9. The conjugated polyelectrolyte according to claim 4, wherein the ionic group is selected from the group consisting of an amine, imidazolium, pyridinium, sulfonate, and carboxylate.

10. The conjugated polyelectrolyte according to claim 1, wherein each of the polar nonionic sidechains includes at least one oligo(ethylene glycol) branch extending from a monomer of the plurality of monomers.

11. The conjugated polyelectrolyte according to claim 10, wherein oligo((ethylene glycol) includes four or more ethylene glycol units.

12. The conjugated polyelectrolyte according to claim 10, wherein each of the polar nonionic sidechains is selected from the group consisting of aldehyde (R—CHO), ester (R—COOR′), amide (R—CONR′R″), ketone (R—COR′), cyano (R—CN), primary amine (R—NH₂), secondary amine (R—NR′H), tertiary amine (R—NR′R″), and alcohol (R—OH), wherein R is a linear or branched alkyl group extending from a monomer of the plurality of monomers, R′ and R″ are alkyl groups.

13. A coacervate composition comprising:
an aqueous solution of a salt; and
a conjugated polyelectrolyte including:
a conjugated polymer backbone including a plurality of monomers;
ionic sidechains; and
polar nonionic sidechains, wherein each of the ionic sidechains and each the polar nonionic sidechains extends from each monomer of the plurality of monomers in an alternating manner.

14. The coacervate composition according to claim 13, wherein the salt includes at least one cation of K⁺, Ca²⁺, Mg²⁺, Fe²⁺, or Fe³⁻.

15. The coacervate composition according to claim 13, wherein the plurality of monomers is selected from the group consisting of fluorene, phenylene, thiophene, benzothiadiazole, bithiophene, benzodithiophene, thienothiophene, and carbazole.

16. The coacervate composition according to claim 13, wherein each of the ionic sidechains includes an ionic group and at least one alkyl group disposed between one monomer of the plurality of monomers and the ionic group.

17. The coacervate composition according to claim 13, wherein each of the polar nonionic sidechains includes at least one oligo(ethylene glycol) branch extending from a monomer of the plurality of monomers.

18. The coacervate composition according to claim 13, wherein the conjugated polyelectrolyte is configured to form a liquid coacervate phase in the aqueous solution.

19. A coacervate composition comprising:
an aqueous solution of a salt;
a first conjugated polyelectrolyte including:
a conjugated polymer backbone including a plurality of monomers;
ionic sidechains; and
polar nonionic sidechains, wherein each of the ionic sidechains and each the polar nonionic sidechains extends from each monomer of the plurality of monomers in an alternating manner; and
a second conjugated polyelectrolyte having an opposite charge from the first conjugated polyelectrolyte.

20. The coacervate composition according to claim 19, wherein the second conjugated polyelectrolyte is anionic poly(cyclopentadithieno-alt-phenylene).
